(19) United States
(12) Patent Application Publication
(10) Pub. No.: US 2025/0073888 A1
(43) Pub. Date: Mar. 6, 2025

(54) TOOL HOLDER

(71) Applicant: Walter R. Tucker Enterprises, Ltd. D/B/A E-Z Red Company, Deposit, NY (US)

(72) Inventor: Robert CACCIABEVE, Denville, NJ (US)

(73) Assignee: Walter R. Tucker Enterprises, Ltd. D/B/A E-Z Red Company, Deposit, NY (US)

(21) Appl. No.: 18/819,412

(22) Filed: Aug. 29, 2024

Related U.S. Application Data
(60) Provisional application No. 63/535,438, filed on Aug. 30, 2023.

(51) Int. Cl. B25H 3/00; F16M 13/02

(52) U.S. Cl. CPC B25H 3/00; F16M 13/022

(57) ABSTRACT

A tool holder for holding different size and shaped tools having flexible inserts to receive and hold a tool. The tool holder includes one or more magnets to attach the tool holder to a metal surface.

### RELATED APPLICATION

This application claims benefit of U.S. Provisional Application Ser. No. 63/535,438, filed Aug. 30, 2023, entitled “Tool Holder,” which application is incorporated herein by reference in its entirety.

### FIELD OF THE INVENTION

The present invention relates to a tool holder. More particularly, the invention relates to a tool holder which will securely hold many different shapes and sizes of tools.

### BACKGROUND OF THE INVENTION

Tool holders are known in the art. For example, the E-Z Red Company sells a tool holder for holding wrenches such disclosed in U.S. Pat. No. 12,023,785, entitled “Flexible Magnetic Wrench Holder,” which is incorporated herein by reference. Similarly, the E-Z Red Company sells a tool holder for holding sockets for wrenches as disclosed in U.S. Pat. No. 11,504,843, entitled “Flexible Magnetic Socket Holder,” which is incorporated herein by reference. Another E-Z Red Company related product is a “Flexible Magnetic Spray Can Holder” as disclosed in U.S. Pat. No. 11,892,121, which is incorporated herein by reference. While these inventions are very useful, they are primarily for one tool. It would be useful to have a tool holder that will hold different shapes and sizes of tools and fit them securely into the holder.

Accordingly, these known tool holders, while useful, may be improved upon. The present invention provides such an improvement.

### SUMMARY OF THE INVENTION

The present invention is directed to a tool holder that will securely hold tools of different shapes and sizes in the holder.

A primary object of the invention is to provide a universal tool holder.

Another primary object of the invention is to provide a tool holder that may securely hold tools of different shapes and sizes in the holder.

Another primary object of the invention is to provide a tool holder that uses flexible inserts in the tool holder housing to secure tools of different shapes and sizes in the holder.

Another primary object of the invention is to provide two different size tool holders, one for holding larger tools and one for holding smaller tools.

Another primary object of the invention is to provide a tool holder to securely hold tools of different shapes and sizes in the holder and which includes magnets to attach the tool holder to a metal surface.

Another primary object of the invention is to provide a tool holder to securely hold tools of different shapes and sizes in the holder and which includes magnets to attach the tool holder to a metal surface, wherein the magnets are held in a steel holder to provide additional magnetic strength.

Another primary object of the invention is to provide a tool holder which will not scratch or mar the surface to which the tool holder is attached, including by use of a thermoplastic elastomer to make the holder and the use of a non-slip pad.

Another primary object of the invention is to provide a tool holder which is modular and which will allow one or more tool holders to be attached together.

Another primary object of the invention is to provide a tool holder for holding different size and shaped tools comprising a front cover and a back plate, one or more flexible inserts attached to the back plate and exposed at the front cover and adapted to receive and hold the tool, a non-slip friction insert attached to the back plate and exposed through an opening in the back plate, and one or more magnets attached to the back plate and exposed through one or more openings in the back plate and adapted to attach the tool holder to a metal surface.

The present invention is directed to a tool holder which will securely hold tools of different shapes and sizes in the holder. The holder is preferably made of plastic and includes a front cover, flexible inserts, a non-slip fiction insert, one or more magnets and a back plate. The flexible inserts, preferably an elastomer, are constructed and arranged to allow the holder to receive and hold different shapes and sizes of tools. The flexible inserts will expand and contract in part to adjust to the shape of the tool being held. The magnets will allow the tool holder to be attached to a metal surface and the non-slip friction insert will prevent the tool holder from moving when a tool is inserted into the tool holder when attached to a metal surface by the magnets.

These primary and other objects of the invention will be apparent from the following description of the preferred embodiments of the invention and from the accompanying drawings.

### BRIEF DESCRIPTION OF THE DRAWINGS

The following detailed description of the specific non-limiting embodiments of the present invention can be best understood when read in conjunction with the following drawings, where like structures are indicated by like reference numbers.

Referring to the drawings:

FIG. 1 is a front and side perspective view of a first embodiment of the tool holder invention.

FIG. 2 is a back and side perspective view of the tool holder of FIG. 1.

FIG. 3A is a front view of the tool holder of FIG. 1.

FIG. 3B is a cross-section of the tool holder of FIG. 3A taken along lines A-A.

FIG. 3C is a cross-section of the tool holder of FIG. 3A taken along lines B-B.

FIG. 3D is an enlarged view of section C of FIG. 3C.

FIG. 4 is a back view of the tool holder of FIG. 1.

FIG. 5 is a first side view of the tool holder of FIG. 1.

FIG. 6 is a second side view of the tool holder of FIG. 1.

FIG. 7 is a top view of the tool holder of FIG. 1.

FIG. 8 is a bottom view of the tool holder of FIG. 1.

FIG. 9 is a top and front perspective view of the tool holder of FIG. 1.

FIG. 10 is an exploded view of the tool holder of FIG. 1.

FIG. 11 is another exploded view of the tool holder of FIG. 1.

FIG. 12 is a top and side perspective view of a second embodiment of the tool holder invention.

FIG. 13 is a back and side perspective view of the tool holder of FIG. 12.

FIG. 14A is a front view of the tool holder of FIG. 12.

FIG. 14B is a cross-section of the tool holder of FIG. 14A taken along lines D-D.

FIG. 14C is a cross-section of the tool holder of FIG. 14A taken along lines E-E.

FIG. 14D is an enlarged view of section F of FIG. 14C.

FIG. 15 is a back view of the tool holder of FIG. 12.

FIG. 16 is a first side view of the tool holder of FIG. 12.

FIG. 17 is a second side view of the tool holder of FIG. 12.

FIG. 18 is a top view of the tool holder of FIG. 12.

FIG. 19 is a bottom view of the tool holder of FIG. 12.

FIG. 20 is an exploded view of the tool holder of FIG. 12.

### DETAILED DESCRIPTION OF THE PREFERRED EMBODIMENTS

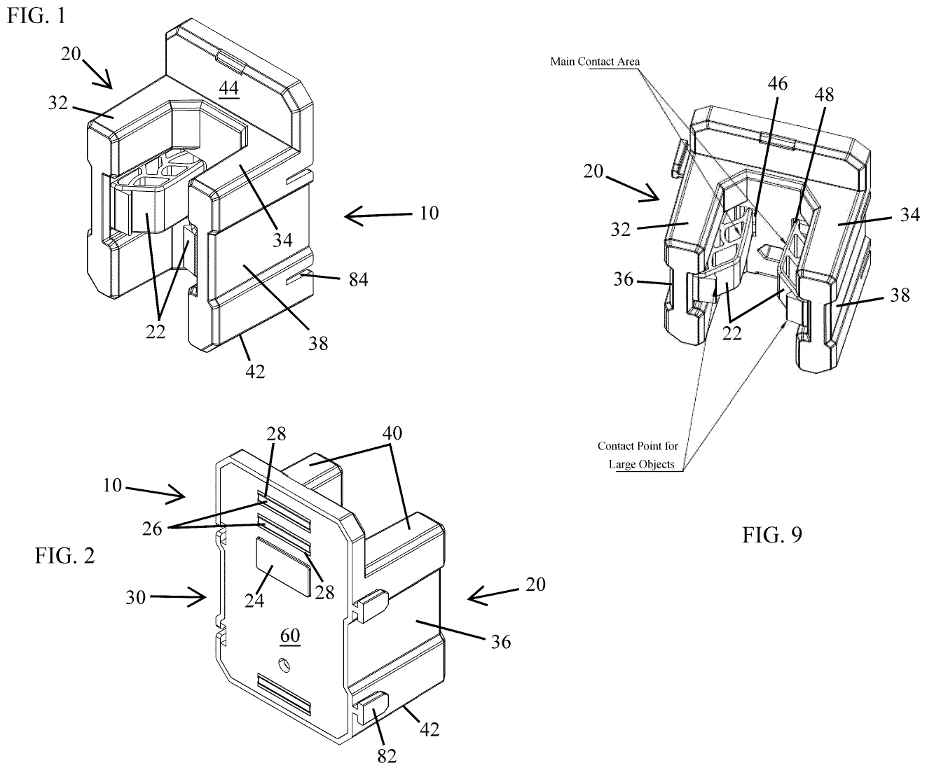

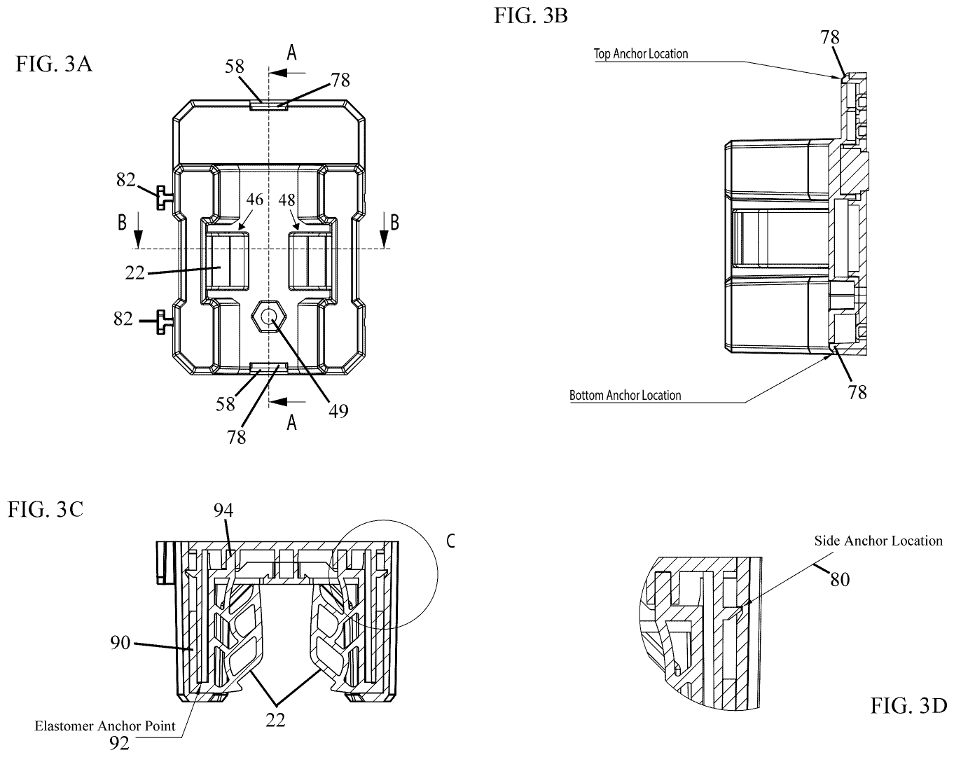

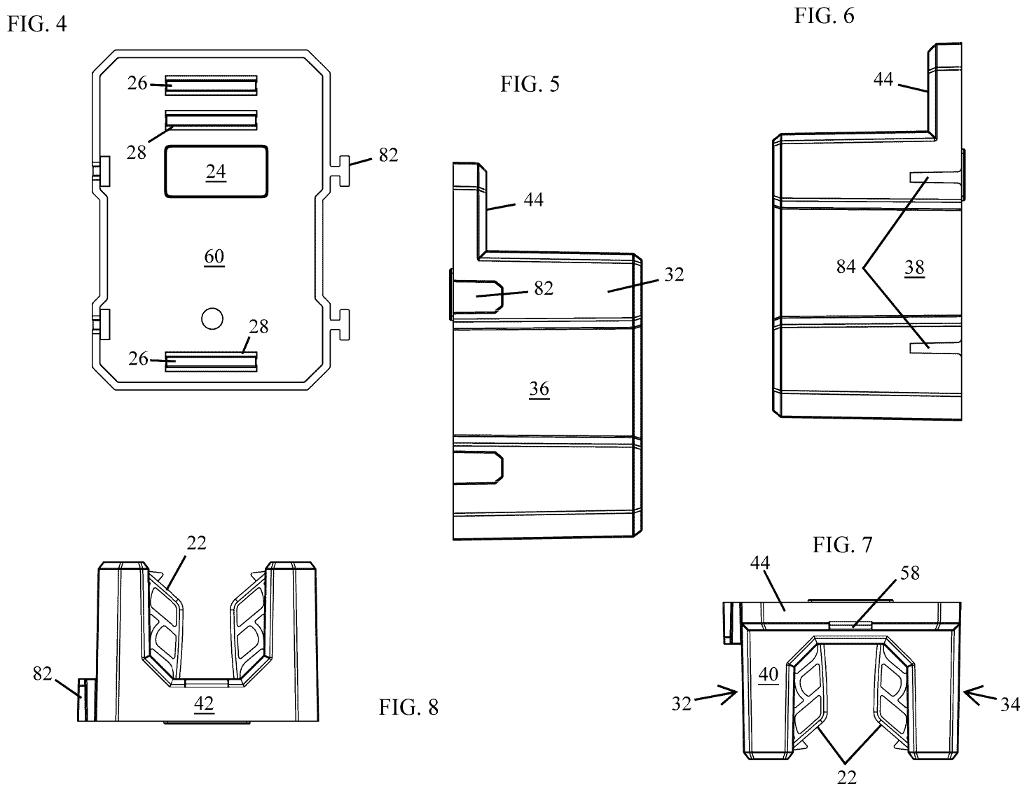

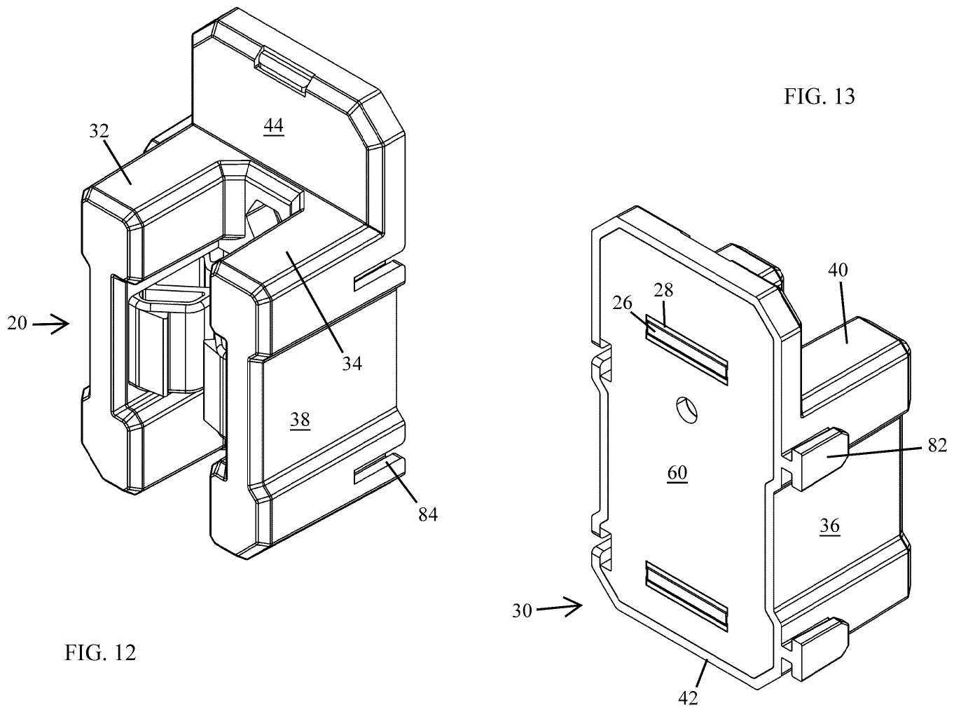

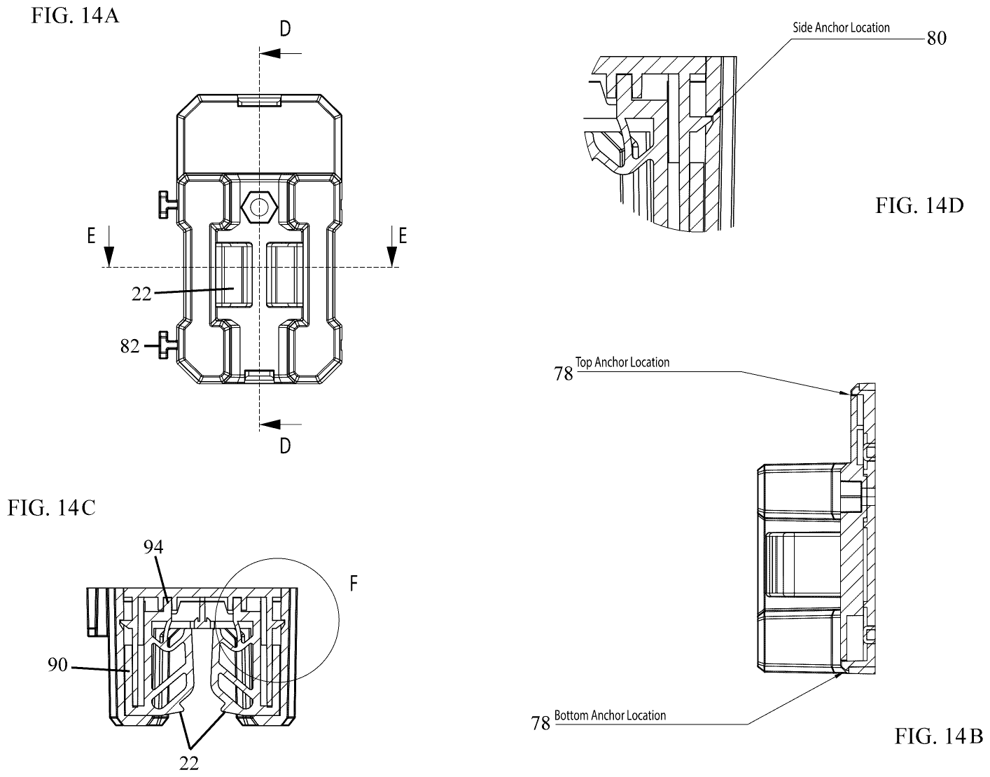

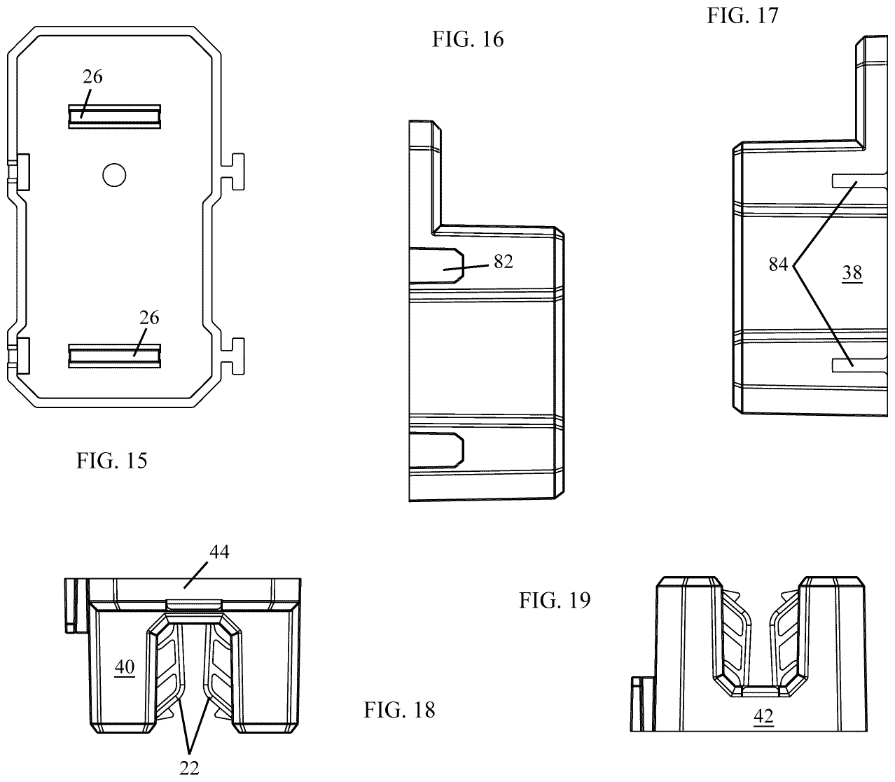

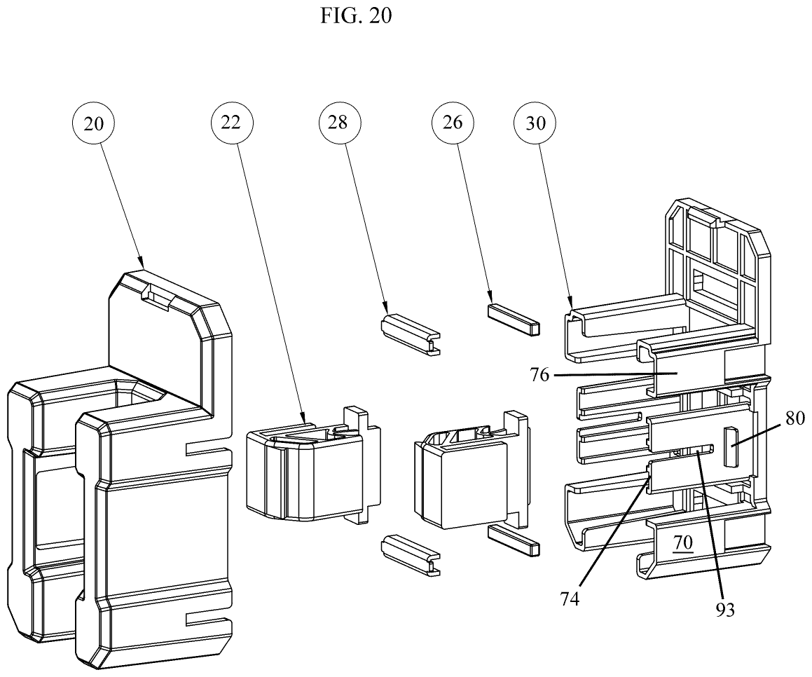

The invention is directed to a tool holder which will securely hold tools of different shapes and sizes in the holder. One embodiment of the tool holder is shown in FIGS. 1-11 and will hold larger tools. A second embodiment of the invention is shown in FIGS. 12-20 which will hold smaller tools. The invention is significant in that it will hold different shapes and sizes of tools based on its construction.

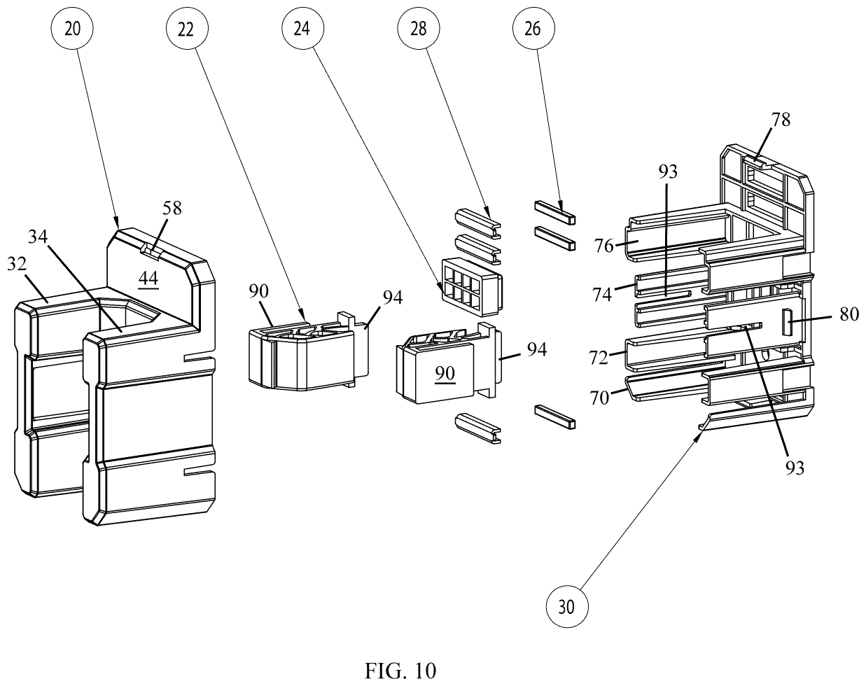

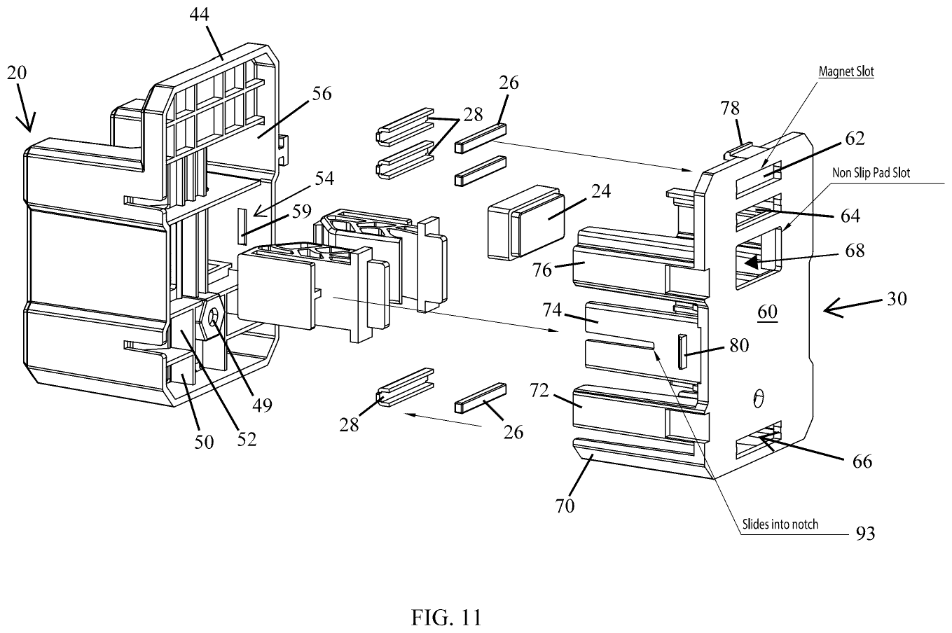

Referring to FIGS. 1-11, there is disclosed a tool holder 10 having a front cover 20 preferably made of a thermoplastic elastomer, elastomer inserts 22, a non-slip friction insert 24, magnets 26 held in a steel wrapper 28 and a back plate 30 preferably made of a hard plastic such as ABS. FIGS. 10 and 11 show exploded embodiments of the tool holder and the construction of the tool holder.

The front cover 20 includes a first arm 32 and a second arm 34 providing for a generally U-shaped opening for receiving a tool and forming side walls 36 and 38 and a top and bottom walls 40 and 42. Extending upwardly from top wall 40 is an upper wall 44. There are openings 46 and 48 for receiving and retaining elastomer inserts 22 and opening 49 for receiving a fastener to fasten front cover 20 and back plate 30. Referring to FIG. 11, the inside of cover 20 includes openings 50, 52 54 and 56 on each side thereof for receiving corresponding legs from back plate 30 as discussed below to attach back plate 30 to front cover 20. Front cover 20 also includes slots 58 and 59 for receiving corresponding tabs from the back plate 30 as discussed below for connecting the front cover 20 to the back plate 30.

Back plate 30 includes a flat back surface 60 having openings 62, 64 and 66 for the magnets 26 to be exposed and opening 68 for the non-slip insert 24 to extend therethrough. There are legs 70, 72, 74 and 76 on each side which mate with opening 50, 52, 54 and 56 for attaching the back plate 30 to the front cover 20. Back plate 30 also includes top and bottom anchor tabs 78 and side anchor tabs 80 for connecting to slots 58 and 59 in front cover 20 for connecting the front cover 20 to the back plate 30.

The elastomer inserts 22 have a honeycomb construction which provides flexibility and allows for expansion and contraction of the insert 22 for holding a tool. There is a flap 90 and tabs 92 and 94 of the insert 22 for attaching insert 22 to the back plate 30, namely, flap 90 overlaying legs 76 and tabs 92 and 94 mating with corresponding slots 93 in leg 76 of the back plate. Each insert 22 extends through opening 46 and 48 of the front cover.

The elastomer inserts 22 are flexible and serve to hold different size and shapes of tools. The elastomer inserts may expand and contract in multiple directions in order to hold the tool in place. In this first embodiment, there are two magnets 26 exposed at the top of back plate 30 and one magnet 26 exposed at the bottom of back plate 30. The tool holder may be attached to metal surfaces by magnets 26. The non-slip friction insert 24, preferably made of an elastomer material, extending from back plate 30 and prevents marring of the metal surface to which the tool holder is attached and will also keep the tool holder from moving downward when a tool is inserted.

The tool holder is modular and includes projections 82 on one side of the tool holder which will mate with slots 84 on the other side of another tool holder to join one or more tool holders together.

A second smaller embodiment of the tool holder for smaller tools is tool holder 10A shown in FIGS. 12-20 and is substantially similar to the first embodiment except that is uses only two magnets 26 and is smaller in dimension. Like reference numbers are used for tool holders 10 and 10A with the understanding that the size of tool holders 10 and 10A is different.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

1. A tool holder for holding different size and shaped tools comprising a front cover and a back plate, one or more flexible inserts attached to the back plate and exposed at the front cover and adapted to receive and hold the tool, a non-slip friction insert attached to the back plate and exposed through an opening in the back plate, and one or more magnets attached to the back plate and exposed through one or more openings in the back plate and adapted to attach the tool holder to a metal surface.
